(19) United States
(12) Patent Application Publication
(10) Pub. No.: US 2022/0285753 A1
(43) Pub. Date: Sep. 8, 2022

(54) AIRCRAFT BATTERY PACK AND ASSOCIATED COOLING SYSTEM

(71) Applicant: Bell Textron Inc., Fort Worth, TX (US)

(72) Inventors: Joseph Dean Rainville, Fort Worth, TX (US); Dakota Easley, Dallas, TX (US)

(73) Assignee: Bell Textron Inc., Fort Worth, TX (US)

(21) Appl. No.: 17/193,771

(22) Filed: Mar. 5, 2021

(51) Int. Cl. H01M 10/625; H01M 10/613; H01M 10/6568; H01M 10/643; H01M 10/6566; B64D 27/24; B64D 33/08; B64C 27/32; B60L 50/60; B60L 58/26

(52) U.S. Cl. CPC H01M 10/625; H01M 10/613; H01M 10/6568; H01M 10/643; H01M 10/6566; B64D 27/24; B64D 33/08; B64C 27/32; B60L 50/60; B60L 58/26; H01M 2220/20; B60L 2200/10

(57) ABSTRACT

An electric-powered aircraft battery pack and associated battery pack cooling system. The battery pack comprises a plurality of thermally conductive cooling plates and at least one battery cell coupled with each cooling plate. Heat generated by the battery cells is transferred by conduction to the associated cooling plate. The heat carried by the cooling plates is then transferred by convection to a fluid medium. In some embodiments, heat is transferred from the cooling plate to ambient air or ram air of the aircraft. In some embodiments, heat is transferred from the cooling plate to coolant liquid of a battery pack cooling system.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Some electric-powered aircraft rely on an onboard battery system as an electricity power-source for powering the aircraft. In addition to creating electrical energy for powering the aircraft, battery cells of the battery system can also generate a significant amount of heat during operation. If the battery cells generate too much heat, the battery system can overheat and reduce certain performance metrics of the aircraft, and could even lead to failure of the battery system. Aircraft that do not incorporate any additional measures for cooling the battery system are more likely to overheat and underperform.

### BRIEF DESCRIPTION OF THE DRAWINGS

FIG. 1 illustrates an oblique view of an aircraft according to an embodiment of this disclosure.

FIG. 2 illustrates a cutaway view of a nacelle of the aircraft of FIG. 1.

FIG. 3 illustrates an oblique view of a battery pack of the nacelle of FIG. 2.

FIG. 4 illustrates a top view of the battery pack of FIG. 3.

FIG. 5 illustrates a side view of the battery pack of FIG. 3.

FIG. 6 illustrates a top view of another embodiment of a battery pack according to this disclosure.

FIG. 7 illustrates a flowchart of a method of cooling a battery pack according to an embodiment of this disclosure.

FIG. 8 illustrates a side view of another aircraft according to an embodiment of this disclosure.

FIG. 9 illustrates a schematic diagram of a battery system of the aircraft of FIG. 8.

FIG. 10 illustrates an oblique view of the battery system of FIG. 9.

FIG. 11 illustrates an oblique view of a battery assembly of the battery system of FIG. 10.

FIG. 12 illustrates a cooling loop of the battery system of FIG. 10.

FIG. 13 illustrates an oblique view of another embodiment of a battery assembly of a battery system according to this disclosure.

FIG. 14 illustrates an oblique view of another embodiment of a battery system according to this disclosure.

FIG. 15 illustrates a top view of the battery system of FIG. 14.

FIG. 16 illustrates a cooling loop of the battery system of FIG. 14.

FIG. 17 illustrates a battery assembly of the battery system of FIG. 14.

FIG. 18 illustrates a flowchart of a method of cooling a battery assembly according to an embodiment of this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure provides an electric-powered aircraft battery pack and associated battery pack cooling system. The battery pack comprises a plurality of thermally conductive cooling plates and at least one battery cell coupled with each cooling plate. Heat generated by the battery cells can be transferred by conduction to the associated cooling plate. The heat carried by the cooling plates is then transferred by convection to a fluid medium. In some embodiments, heat is transferred from the cooling plate to ambient air or ram air of the aircraft. In some embodiments, heat is transferred from the cooling plate to coolant liquid of a battery pack cooling system.

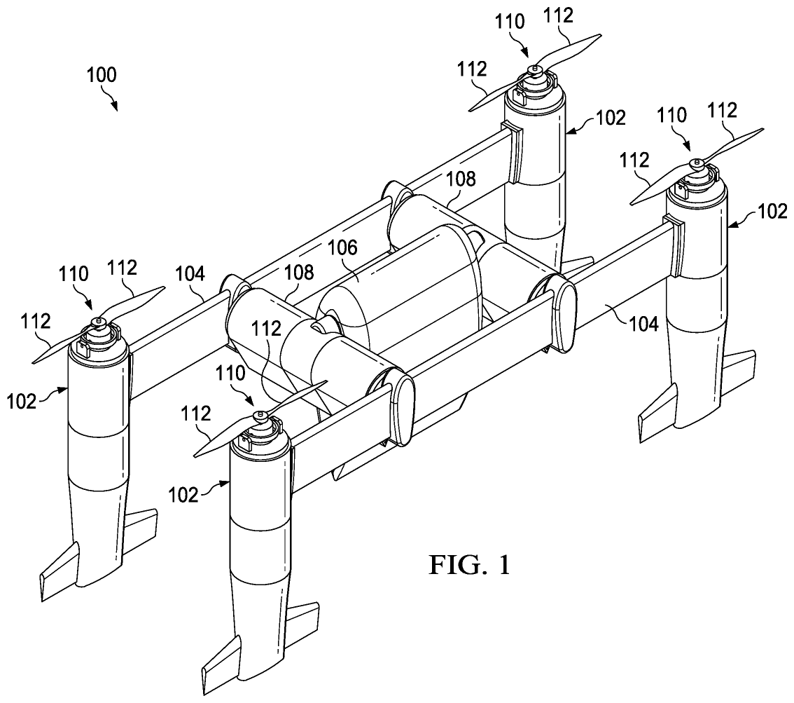

FIG. 1 illustrates an oblique view of a tailsitter unmanned aerial vehicle (“UAV”) 100 operable to transition between thrust-borne lift in a vertical takeoff and landing (“VTOL”) orientation and wing-borne lift in a biplane orientation. In some embodiments, UAV 100 is a Bell Autonomous Pod Transport (“APT”) aircraft. In the VTOL orientation, thrust modules 102 provide thrust-borne lift and, in the biplane orientation, thrust modules 102 provide forward thrust and the forward airspeed of UAV 100 provides wing-borne lift. Thrust modules 102 are mounted to wings 104, which generate lift responsive to forward airspeed when the UAV 100 is in the biplane orientation. Wings 104 are mounted to a payload 106 of UAV 100 by trusses 108. Each thrust module 102 includes a rotor assembly 110 with propellers 112 configured to rotate to provide thrust and direct ram air and propeller wash toward thrust module 102.

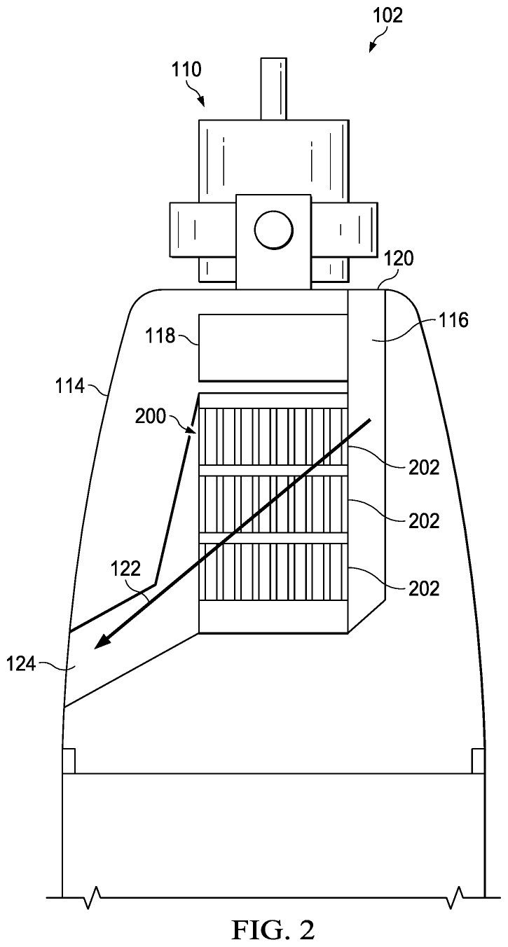

Referring to FIG. 2, each thrust module 102 includes a nacelle 114 which houses a passive ram air channel 116 configured to direct passive ambient air from outside of aircraft 100 toward a battery system 200. In some cases, the air flowing through channel 116 can be ram air that enters channel 116 based on dynamic pressure created by the motion of aircraft 100. In some cases, the air flowing through channel 116 can be propeller wash displaced by propellers 112. In some cases, air flowing through channel 116 is a combination of ram air and propeller wash. Although this disclosure refers to the air passing through channel 116 as “ram air,” one with skill in the art will understand that any of a number of sources can force air through channel 116, such propeller wash displaced by rotor assembly 110. Additionally, air channel 116 may have a thermally passive or actively controlled inlet bypass flap to allow for battery warm up during colder conditions.

Operation of thrust module 102 and battery system 200 can be controlled by electronics node 118. Electronics node 118 preferably includes non-transitory computer readable media including a set of computer instructions executable by one or more processors for controlling operation of the thrust module 102 and battery system 200. Battery system 200 is configured to provide electrical power to thrust module 102 to power rotor assembly 110. Ram air enters channel 116 from an inlet 120 and travels along an air path 122 where it then exits channel 116 at an outlet 124. Accordingly, ram air travels through channel 116 past battery system 200 and, in doing so, can cool battery system 200. Battery system 200 includes a plurality of battery packs 202 configured to generate electrical energy. Battery packs 202 can be connected in series or in parallel to increase the output thereof. Although FIG. 2 illustrates battery system 200 as comprising three battery packs 202, one with skill in the art will understand that battery system 200 can have fewer or more than three battery packs 202 according to output requirements for powering thrust module 102.

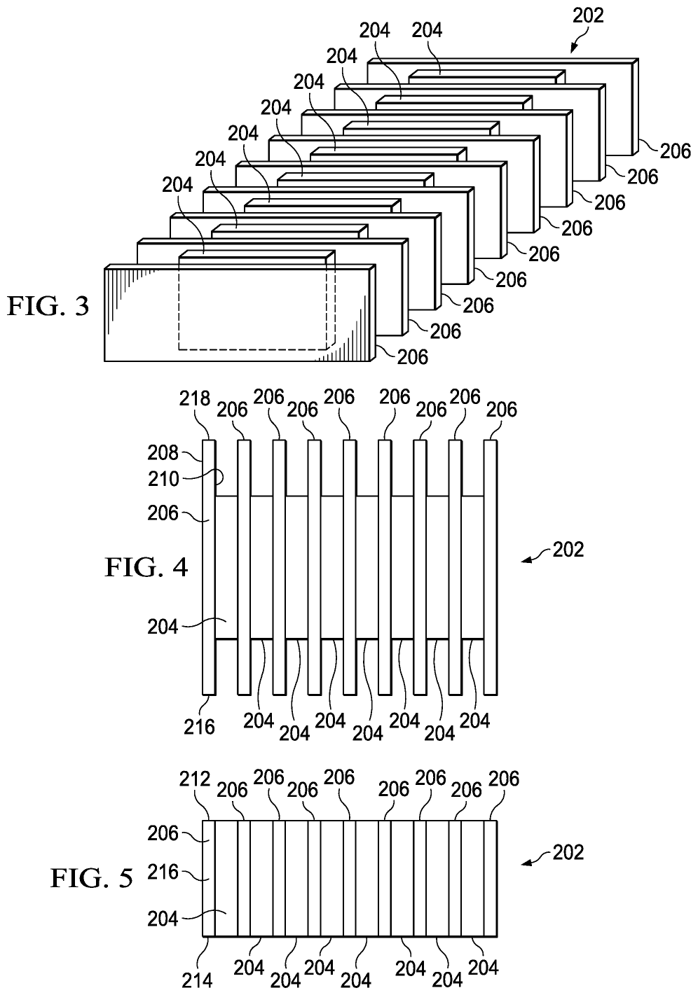

Referring to FIG. 3, battery packs 202 include a plurality of battery cells 204 configured to provide electrical energy for powering thrust module 102. Battery cells 204 can be any suitable type of battery configured to provide electrical energy. In some embodiments, each battery cell 204 is a rechargeable battery. In some embodiments, each battery cell 204 is a lithium-ion battery. Battery cells 204 may be round cylinders, flat packs, or any other suitable geometric shape.

Battery packs 202 further include a plurality of cooling members 206. As illustrated in the figures, battery cells 204 and cooling members 206 are alternatingly stacked such that a cooling member 206 is disposed between adjacent battery cells 204. Battery cells 204 are coupled to cooling members 206 so that heat generated by battery cells 204 can be transferred to the associated cooling members 206 by conductive heat transfer. In some embodiments, internally located battery cells 204 are coupled to two adjacent cooling members 206 with a thermally conductive adhesive. Each battery cell 204 can be coupled to adjacent cooling members 206 by any means that allow for conductive heat transfer between the battery cell 204 and the cooling members 206.

During operation of thrust module 102, battery cells 204 can produce a significant amount of heat. It is beneficial to remove the heat from battery cells 204 to prevent battery cells 204 from overheating. As previously mentioned, heat produced by battery cells 204 can be transferred to cooling members 206 by conductive heat transfer. Cooling members 206 can be made of a highly thermally conductive composite material so that heat can efficiently be transferred between battery cells 204 and cooling members 206. In some embodiments, cooling members 206 comprise a graphite based plate. For example, the cooling members 206 can comprise the flexible graphite Grafoil® owned by GrafTech. In some embodiments, cooling members 206 comprise a metallic material. One with skill in the art will understand that the cooling members 206 can comprise any thermally conductive material that could be configured to absorb heat from battery cells 204.

Referring to FIGS. 3-5 each battery cell 204 and cooling member 206 comprise a generally rectangular cuboid shape. Each cooling member 206 has a front side 208, back side 210, top side 212, bottom side 214, right side 216, and left side 218. Cooling members 206 have more surface area than battery cells 204 and increase the exposed surface area available for cooling by the ram air as the ram air travels along path 122 past battery packs 202. As illustrated in FIG. 4, the length of cooling members 206 between sides 214 and 216 is greater than the length of battery cells 204 such that the cooling members 206 extend outward past the left and right sides of the battery cells 204. Accordingly, cooling members 206 can be described as acting as cooling fins that transfer heat generated by battery cells 204 to ram air traveling through air channel 116 along path 122 via convective heat transfer.

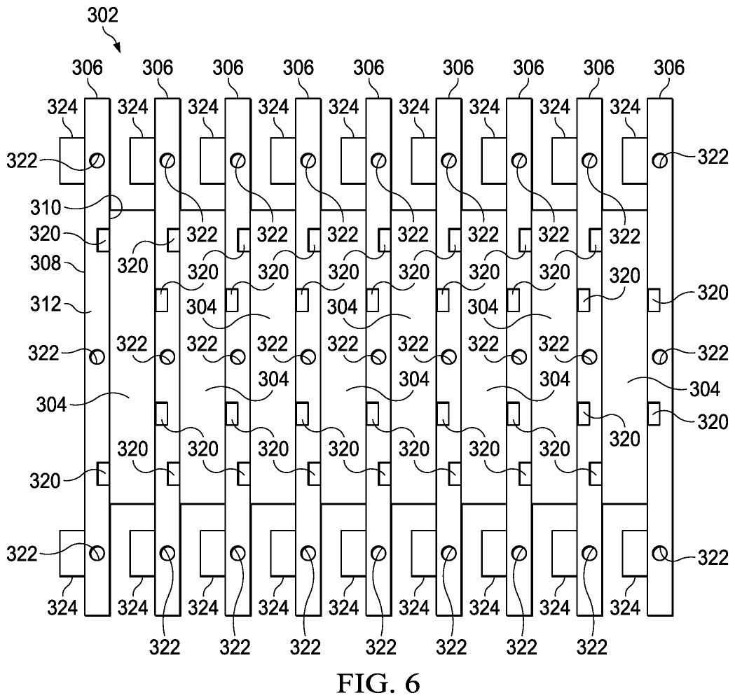

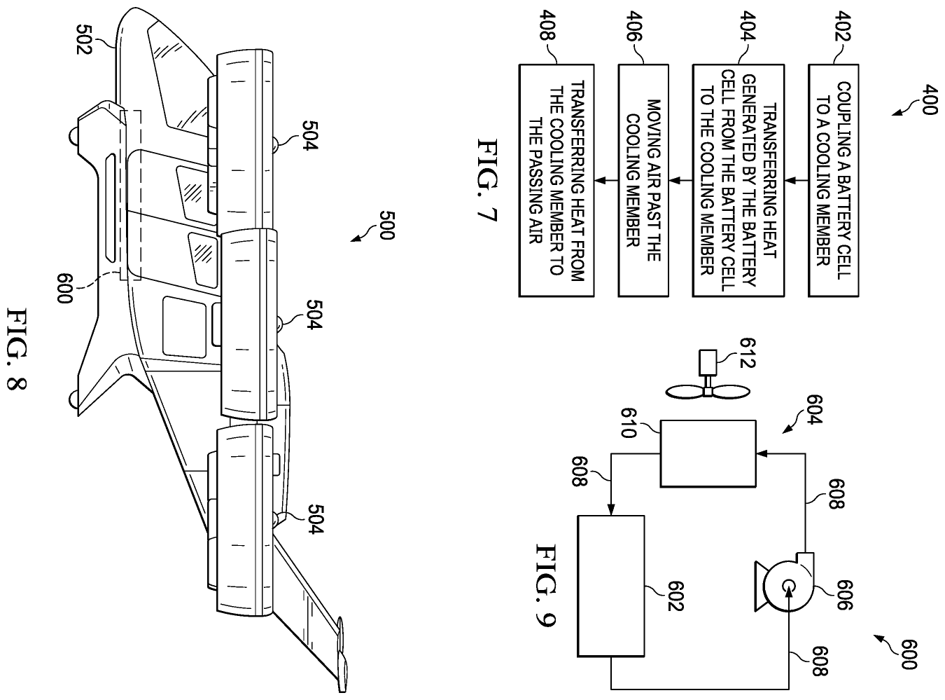

Referring to FIG. 6, an alternative embodiment of a battery pack 302 is shown. Battery pack 302 can be substantially similar to battery pack 202. Battery pack 302 has a plurality of battery cells 304, which can be substantially similar to battery cells 204, and a plurality of cooling members 306, which can be substantially similar to cooling members 206. Cooling members 306 further include a plurality of airflow passages 320 formed on front sides 308 and back sides 310 of cooling members 306 and extend from top sides 312 to bottom sides of cooling members 306. Airflow passages 320 provide cooling members 306 with more surface area from which heat of battery cells 304 can be transferred to passing ram air. Additionally, passages 320 are formed adjacent to battery cells 304 so that more surface area of battery cells 304 is exposed to passing ram air to further cool battery cells 304 by convective heat transfer. Cooling members 306 also include internal air flow passages 322 formed to extend from top sides 312 to bottom sides 314 of cooling members 306. Unlike passages 320, internal passages 322 are not formed on a surface of cooling member 306 but instead are formed inside the cooling member 306. Internal passages 322 increase available surface area of cooling members 306 exposed to passing ram air. Additionally, according to some embodiments, cooling members 306 further include cooling fins 324 formed on front or back sides 308, 310 of cooling members 306. Fins 324 can extend from top sides 312 to bottom sides 314 of cooling members 306 and further increase available surface area of cooling members 306 exposed to passing ram air.

One with skill in the art will understand that FIG. 6 illustrates just an example of how airflow passages 320, 322 and fins 324 can be arranged on cooling members 306. Airflow passages 320, 322 and fins 324 can comprise any of a number of shapes and sizes and be disposed on cooling members 306 in any of a number or patterns in order to optimize heat transfer from battery cells 304 to the passing ram air.

Referring to FIG. 7, a method 400 of cooling a battery pack assembly, such as battery pack 202 or 302, will be described. At block 402, method 400 can begin by providing a battery cell 204 or 304 and at least one cooling member 206 or 306 and coupling battery cell 204 or 304 to the at least one cooling member 206 or 306. As previously discussed, battery cell 204 or 304 can be bonded to cooling member 206 or 306 with a thermally conductive adhesive, or by any other means that allows for conductive heat transfer between cooling member 206 or 306 and battery cell 204 or 304. At block 404, method 400 can continue by transferring heat generated by battery cell 204 or 304 to the at least one cooling member 206 or 306 via conductive heat transfer. At block 406, method 400 can continue by moving air over battery pack 202 or 302. As previously discussed, battery pack 202 or 302 is disposed in channel 116 where ram air moves past battery pack 202 or 302 along path 122. At block 408, method 400 can continue by transferring the heat stored by cooling member 206 or 306 to the passing ram air via convective heat transfer.

Referring now to FIG. 8, an electric-powered thrust rotor aircraft 500 operable to transition between thrust-borne lift in a VTOL orientation and wing-borne lift in an airplane orientation is shown. In some embodiments, aircraft 500 is the electric-powered Bell Nexus aircraft. Aircraft 500 can include a fuselage 502 and a plurality of rotor assemblies 504 connected to the fuselage 502. In the VTOL orientation, rotor assemblies 504 provide thrust-borne lift and, in the airplane orientation, rotor assemblies 504 provide forward thrust and the forward airspeed of aircraft 500 provides wing-borne lift. Rotor assemblies 504 are electrically powered by a battery system 600 disposed in fuselage 502.

Referring to FIG. 9, battery pack and cooling system 600 includes a battery pack 602 and a cooling system 604 configured to cool battery pack 602 by absorbing heat generated by battery pack 602. According to some embodiments, cooling system 604 is a liquid cooling system configured to draw heat generated by battery pack 602 into a coolant liquid of the system and then transfer the heat stored by the liquid to ambient air of the system 600. The coolant liquid used in cooling system can be any liquid used to transfer heat, such as water or a refrigerant. Cooling system 604 includes a liquid pump 606 configured to pump the liquid through a fluid loop 608 of system 604. Cooling system 604 also includes a heat exchanger 610 configured to transfer heat from the coolant liquid to ambient air of the system 604. In some embodiments, heat exchanger 610 is a tube-and-fin heat exchanger that directs the coolant fluid of the system 604 through tubes of the heat exchanger 610 and transfers heat from the coolant liquid to ambient air through fins attached to the tube. In some embodiments, ram air can be ducted from an outside of aircraft 500 to cooling system 604 to cool heat exchanger 610. In some embodiments, cooling system 604 includes an additional cooling fan 612 to blow ambient air past heat exchanger 610 to cool the coolant fluid. As illustrated by the arrows of fluid loop 608, pump 606 pumps cooled fluid from a fluid outlet of heat exchanger 610 and through the battery pack 602 so that heat created by battery pack 602 can be transferred to the coolant fluid in fluid loop 608 by convective heat transfer. After passing through battery pack 602, the fluid becomes heated due to absorbing the heat from battery pack 602, and the heated fluid is pumped back to the heat exchanger 610 where the heat is then transferred to the ambient air of the system 604. After being cooled, the liquid can again be delivered to cool battery pack 602.

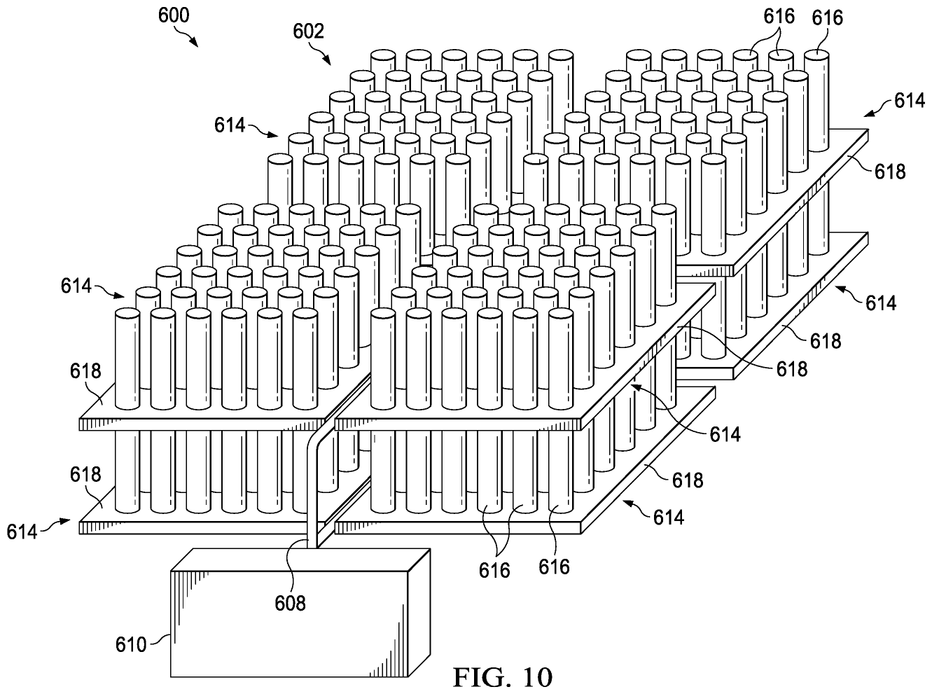

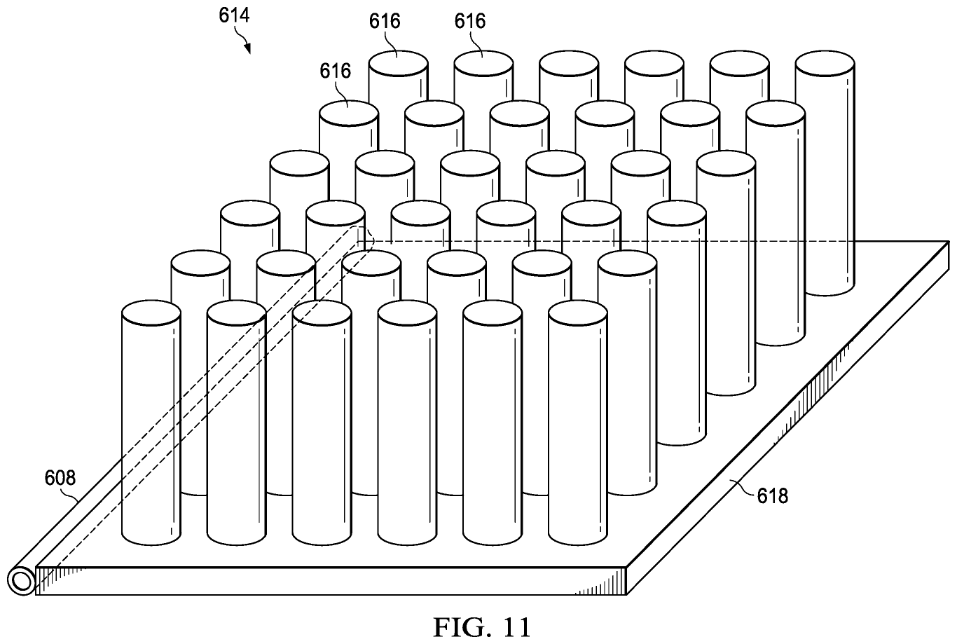

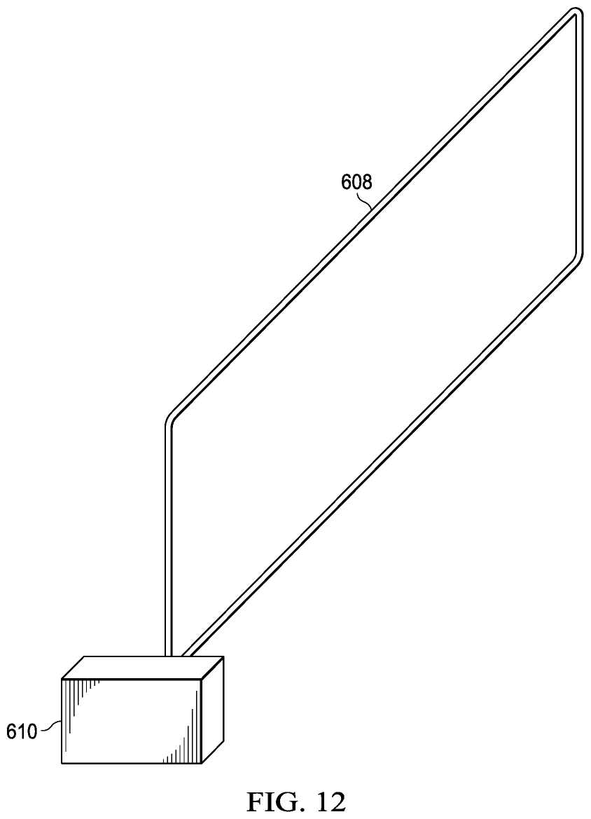

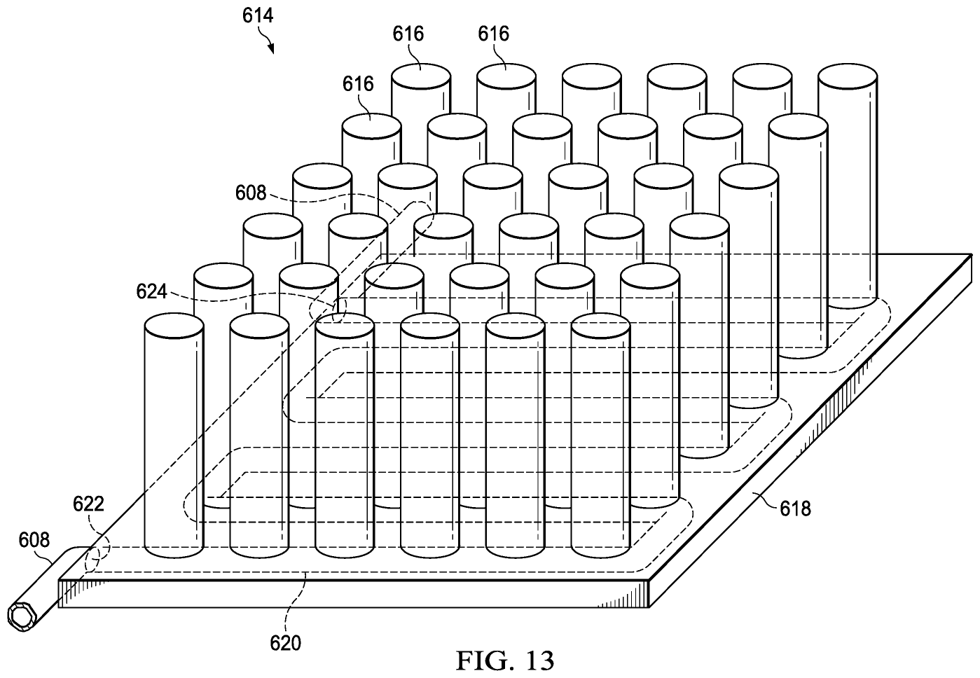

Referring to FIGS. 10-12, battery pack 602 includes a plurality of battery assemblies 614 configured to provide electrical energy for powering components of aircraft 500, such as rotor assemblies 504. The plurality of battery assemblies 614 can be connected to each other in series or parallel to increase the output thereof. Each of the battery assemblies 614 includes a plurality of battery cells 616 configured to provide electrical energy. Battery cells 616 can be substantially the same as battery cells 204 previously described. Battery cells 616 can be any battery cell that is made to provide electrical energy and, in some embodiments, each battery cell 616 is a rechargeable battery. In some embodiments, each battery cell 616 is a lithium-ion battery.

In some embodiments, as illustrated in FIGS. 10 and 11, battery cells 616 comprise a substantially cylindrical shape. For each battery assembly 614, battery cells 616 are coupled to a cooling member 618 of the battery assembly 614, which can be substantially the same as cooling member 206 previously described. A generally circular base surface of each of the cylindrically shaped battery cells 616 is mounted to cooling member 618, and in some embodiments is bonded to cooling member 618 with a thermally conductive adhesive. Cooling members 618 are made of a highly thermally conductive composite material so that heat generated by battery cells 616 can be efficiently transferred to cooling members 618 by conductive heat transfer. In some embodiments, cooling members 618 comprise a graphite based plate. For example, the cooling members 618 can comprise the flexible graphite Grafoil® owned by GrafTech. In some embodiments, cooling members 618 comprise a metallic material. However, one with skill in the art will understand that cooling members 618 can comprise any thermally conductive material that allows for conductive heat transfer between battery cells 616 and cooling members 618. FIG. 10 illustrates that battery pack 602 includes eight separate battery assemblies 614. However, one with skill in the art will understand that the battery pack 602 can include fewer or more than eight battery assemblies 614 based on output requirements for powering aircraft 500.

Each cooling member 618 is coupled with fluid loop 608 so that heat transferred from battery cells 616 to cooling member 618 can be transferred to the fluid flowing through fluid loop 608 via convective heat transfer. An inner edge of each of the cooling members 618 is coupled to fluid loop 608. In some embodiments, a thermally conductive adhesive is used to couple cooling members 618 to fluid loop 608. In some embodiments, cooling members 618 are integrally formed with fluid loop 608. Thus, when the coolant fluid is circulated through fluid loop 608, heat from battery cells 616 is transferred from battery cells 616 to cooling members 618 by conduction, and then from the cooling members 618 to the passing coolant fluid in fluid loop 608 by convection.

Referring to FIG. 13, according to other embodiments, each cooling member 618 further includes a coolant fluid passage 620 in fluid communication with fluid loop 608. Fluid passage 620 includes an inlet 622 that accepts circulating fluid from fluid loop 608 so that the coolant fluid can flow from fluid loop 608 throughout fluid passage 620 to an outlet 624 where the fluid can then flow back to fluid loop 608. As illustrated in FIG. 13, fluid passage 620 can have a serpentine shape such that each battery cell 616 is aligned with a run of the serpentine passage 620. In some embodiment, fluid passage 620 is an internal fluid passage formed entirely within an interior of cooling member 618. In some embodiments, fluid passage 620 is an external fluid passage formed on an exterior facing surface of cooling member 618.

Convective heat transfer from battery cells 616 to the coolant fluid of cooling system 604 can be increased by incorporating fluid passage 620 in each cooling member 618. One with skill in the art will understand that, although the FIG. 13 depicts fluid passage 620 as having a serpentine-type shape, fluid passage 620 can be any of a number of shapes in order to maximize convective heat transfer from battery cells 616 to the coolant fluid of cooling system 604.

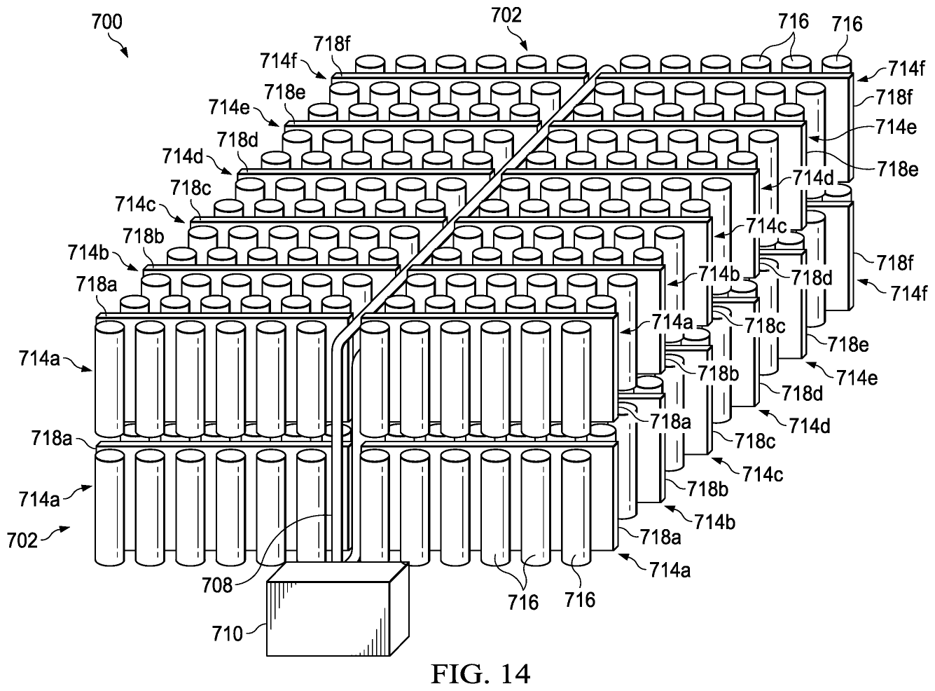

Referring to FIGS. 14-16, another embodiment of a battery system 700 is depicted. Battery system 700 can be substantially similar to battery system 600 and include the various components of battery system 600 previously described. Battery system 700 includes a battery pack 702, which can be substantially similar to battery pack 602, and a coolant system 704, which can be substantially similar to coolant system 604. Coolant system 704 includes a coolant fluid loop 708, which can be substantially similar to coolant fluid loop 608, and a heat exchanger 710, which can be substantially similar to heat exchanger 610.

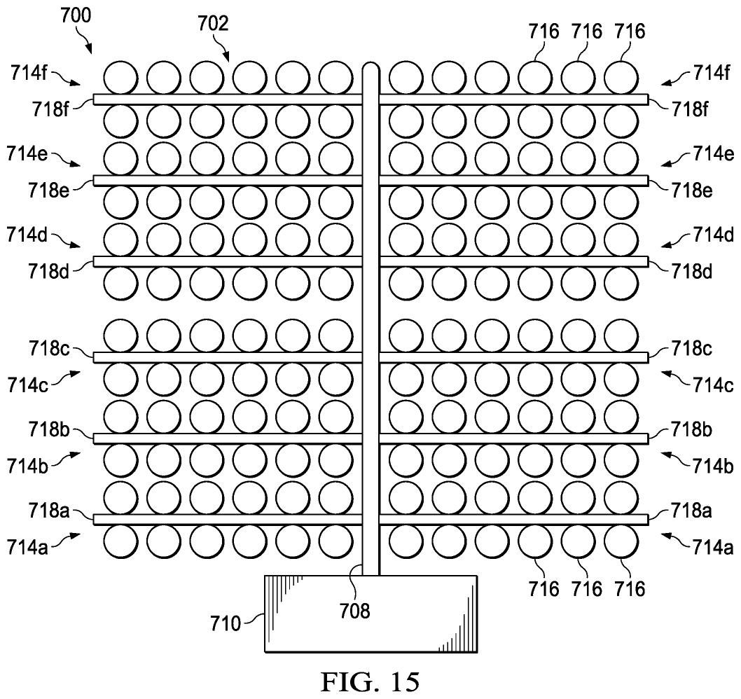

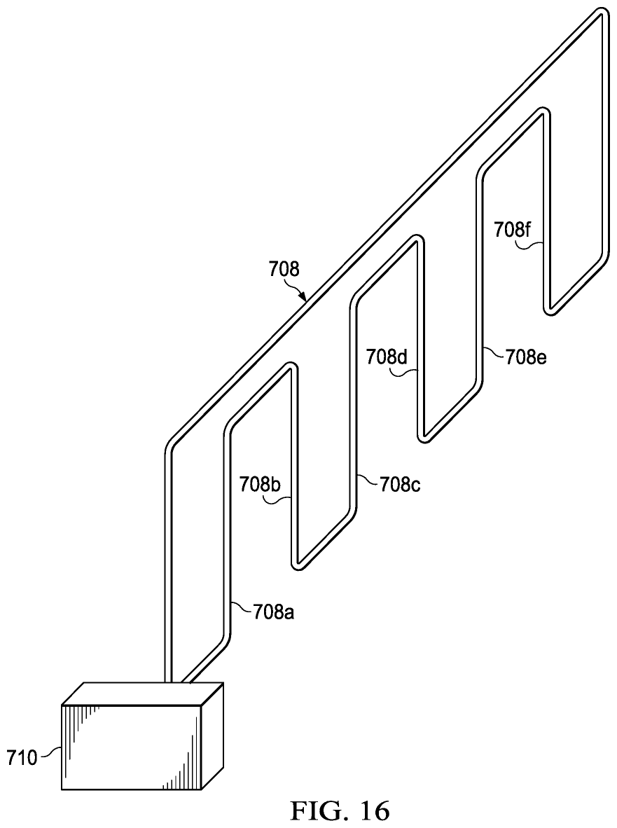

Battery pack 702 includes a plurality of battery assemblies 714, which can be substantially similar to battery assemblies 614. In each of the plurality of battery assemblies 714, cooling member 718 (substantially similar to cooling member 618) is arranged to be substantially parallel with a length of battery cells 716 (substantially similar to battery cells 616). Each cooling member 718 has a front surface and a back surface upon which battery cells 716 are coupled. Accordingly, an outer circumferential surface of each of the battery cells 716 is coupled to a cooling member 718. Similar to the previously discussed embodiment, in this embodiment, each cooling member 718 is coupled with fluid loop 708. In this embodiment, to accommodate the positions of the cooling member 718, fluid loop 708 has a serpentine-type structure, as illustrated in FIG. 16. The four cooling members 718a are coupled to vertical section 708a of loop 708. Likewise, the four cooling members 718b are coupled to vertical section 708b, the four cooling members 718c are coupled to vertical section 708c, the four cooling members 718d are coupled to vertical section 708d, the four cooling members 718e are coupled to vertical section 708e, the four cooling members 718d are coupled to vertical section 708d, and the four cooling members 718f are coupled to vertical section 708f Although FIGS. 14 and 15 illustrate battery pack 702 as having twenty-four battery assemblies 714a-714f, one with skill in the art will understand that battery pack 702 can have fewer or more than twenty-four battery assemblies 714 according to output requirements for powering aircraft 500.

According to various embodiments, each of the cooling members 718a-718f are coupled to the respective sections 708a-708f in the manner previously disclosed in FIG. 11. For example, in some embodiments, each cooling member 718a-718f can be bonded to the respective section 708a-708f using a thermally conductive adhesive. In some embodiments, each cooling member 718a-718f is integrally formed with the respective section 708a-708f.

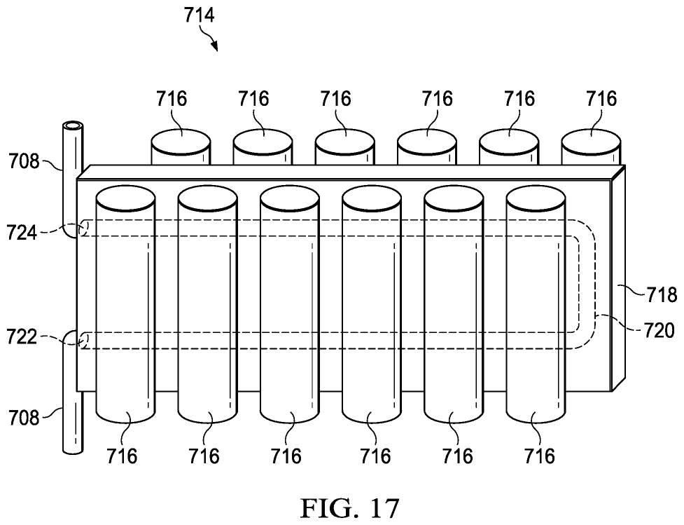

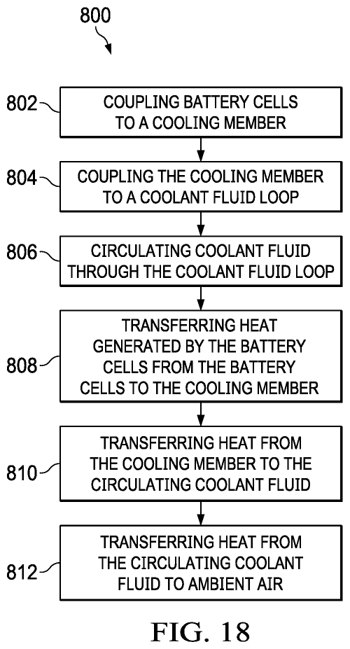

Referring to FIG. 17, similar to the previously described embodiment of FIG. 13, cooling members 718 can further include a fluid passage 720 in fluid communication with the fluid loop 708. Fluid passage 720 includes an inlet 722 that accepts circulating fluid from fluid loop 708 so that the coolant fluid can flow from fluid loop 708 throughout fluid passage 720 to an outlet 724 where the fluid can then flow back to fluid loop 708. In some embodiments, fluid passage 720 is an internal fluid passage formed completely in an interior of cooling member 718. In some embodiments, fluid passage 720 is an external fluid passage formed on an exterior facing surface of cooling member 718. As illustrated in FIG. 18, fluid passage 720 can be generally U-shaped. Heat transfer from battery cells 716 to the fluid of cooling system 704 can be increased by incorporating fluid passage 720 in each cooling member 718 and one with skill in the art will understand that, although FIG. 18 depicts fluid passage 720 as being generally U-shaped, fluid passage 720 can be any of a number of shapes in order to maximize heat transfer from battery cells 716 to the liquid of cooling system 704.

Referring to FIG. 18, a method 800 of cooling a battery pack assembly, such as 614 or 714, is shown. At block 802, method 800 can begin by providing a cooling member 618 or 718 and a plurality of battery cells 616 or 716 and coupling to the plurality of battery cells 616 or 716 to cooling member 618 or 718. As previously discussed, in some embodiments, a base surface of each battery cell 616 can be bonded to cooling member 618 with a thermally conductive adhesive. In some embodiments, an outer circumferential surface of each battery cell 716 can be bonded to cooling member 718 with a thermally conductive adhesive. At block 804, method 800 can continue by coupling cooling member 618 or 718 to coolant loop 608 or 708. As previously described, in some embodiments, a surface of cooling members 618 or 718 can be bonded to coolant loop 608 or 708 with thermally conductive adhesive or cooling member 618 or 718 can be integrally formed with coolant loop 608 or 708. In some embodiments, a passage 620 or 720 of cooling member 618 or 718 is in fluid communication with coolant fluid loop 608 or 708. At block 806, method 800 can continue by circulating the coolant fluid through coolant loop 608 or 708 past cooling member 618 or 718. At block 808, method 800 can continue by transferring heat generated by battery cells 616 or 716 to cooling member 618 or 718 via conductive heat transfer. At block 810, method 800 can continue by transferring heat stored in cooling member 618 or 718 to the circulating coolant fluid of fluid loop 608 or 708 via convective heat transfer. At block 812, method 800 can continue by transferring heat stored in the coolant fluid to ambient air by heat exchanger 610 or 710.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. In an electric-powered aircraft, a method of cooling battery cells used to power the aircraft, comprising:
coupling a battery cell to thermally conductive cooling member;
transferring heat generated by the battery cell to the cooling member; and
transferring heat held by the cooling member to a fluid medium, wherein the fluid medium is at least one of ambient air received from outside of the aircraft and a liquid coolant carried by the aircraft.

2. The method of claim 1, further comprising transferring heat held by the liquid coolant to ambient air with a heat exchanger.

3. The method of claim 1, wherein:
the cooling member comprises a first cooling plate and a second cooling plate; and
the coupling further comprises coupling a first surface of the battery cell to the first cooling plate and a second surface of the battery cell opposing the first surface to the second cooling plate.

4. The method of claim 1, wherein:
the battery cell has a generally cylindrical shape; and
the coupling further comprises coupling a generally circular base surface of the battery cell to the cooling member.

5. The method of claim 1, wherein:
the battery cell has a generally cylindrical shape; and
the coupling further comprises coupling an outer circumferential surface of the battery cell to the cooling member.

6. The method of claim 1, wherein:
the battery cell comprises a plurality of battery cells; and
the coupling further comprises coupling each of the plurality of battery cells to the cooling member.

7. The method of claim 1, further comprising coupling the cooling member to a coolant flow loop through which the fluid medium circulates.

8. The method of claim 1, further comprising moving the fluid medium through a fluid passage of the cooling member.

9. The method of claim 1, further comprising moving the fluid medium from a primary liquid coolant flow loop to a passage of the cooling member.

10. An electric-powered aircraft, comprising
a rotor assembly; and
an air-cooled battery pack, comprising:
a plurality of battery cells disposed along a first direction; and
a plurality of cooling members alternatingly disposed along the first direction with the plurality of battery cells;
wherein air that cools the air-cooled battery pack is at least one of air displaced by the rotor assembly and ambient air received from an outside of the aircraft.

11. The electric-powered aircraft of claim 10, wherein, for each of the plurality of battery cells:
a first surface of the battery cell is coupled to a first adjacent cooling member of the plurality of cooling members; and
a second surface of the battery cell opposing the first surface is coupled to a second adjacent cooling member of the plurality of cooling members.

12. The electric-powered aircraft of claim 10, wherein at least one of the plurality of cooling members comprises a longitudinal air flow passage formed in the cooling member.

13. The electric-powered aircraft of claim 10, wherein each of the plurality of cooling members is a graphite based bipolar plate.

14. The electric-powered aircraft of claim 10, wherein:
each of the plurality of battery cells has a battery length in a second direction perpendicular to the first direction; and
each of the plurality of cooling members has a member length in the second direction greater than the battery length.

15. An electric-powered aircraft, comprising:
at least one rotor assembly; and
a liquid-cooled battery pack configured to power the at least one rotor assembly, comprising:
a liquid cooling system, including a coolant fluid loop in fluid communication with a heat exchanger; and
a battery assembly, including a cooling member coupled to the coolant fluid loop and a plurality of battery cells coupled to the cooling member.

16. The electric-powered aircraft of claim 15, wherein:
each of the plurality of battery cells has a generally cylindrical shape; and
a generally circular shaped base surface of each of the plurality of battery cells is coupled to the cooling member.

17. The electric-powered aircraft of claim 15, wherein:
each of the plurality of battery cells has a generally cylindrical shape; and
an outer circumferential surface of each of the plurality of battery cells is coupled to the cooling member.

18. The electric-powered aircraft of claim 15, wherein the cooling member comprises a fluid passage in fluid communication with the coolant fluid loop.

19. The electric-powered aircraft of claim 18, wherein the fluid passage is an internal passage formed in an interior of the cooling member.

20. The electric-powered aircraft of claim 18, wherein the fluid passage is formed on an outer surface of the cooling member.
